(19) United States
(12) Patent Application Publication
(10) Pub. No.: US 2026/0233303 A1
(43) Pub. Date: Aug. 13, 2026

(54) METHOD FOR MANUFACTURING DUST CORE

(71) Applicant: Panasonic Intellectual Property Management Co., Ltd., Osaka (JP)

(72) Inventors: KAZUKI NOGUCHI, Osaka (JP); TORU IWABUCHI, Kyoto (JP); HITOSHI HORIUCHI, Osaka (JP)

(21) Appl. No.: 19/153,581

(22) PCT Filed: Jan. 16, 2024
(86) PCT No.: PCT/JP2024/000956

§ 371 Date: Aug. 4, 2025

(30) Foreign Application Priority Data
Feb. 22, 2023 (JP) 2023-026171

(51) Int. Cl. B22F 3/03; B22F 1/10; B22F 1/142; B22F 1/17; H01F 41/02

(52) U.S. Cl. CPC B22F 3/03; B22F 1/10; B22F 1/142; B22F 1/17; H01F 41/0246; B22F 2201/00; B22F 2301/205; B22F 2301/35

(57) ABSTRACT

The method for manufacturing a dust core comprises a first step (step S10) of mixing a metal magnetic powder, a resin, and a metal soap to obtain a granular granulated powder, the metal magnetic powder including a plurality of metal magnetic particles, and a second step (step S20) of pressure-molding the obtained granulated powder to obtain a molded body. The metal soap is liquid state at 25° C., and contains Ti element.

### TECHNICAL FIELD

The present disclosure relates to a method for manufacturing a dust core.

### BACKGROUND ART

Conventionally, oxide magnetic materials such as ferrite and metal magnetic materials have been used as magnetic materials for magnetic cores of inductors and transformers. As a magnetic core using these magnetic materials, for example, there is a dust core obtained by compression-molding metal magnetic powder. Such a dust core has a high saturation magnetic flux density and is advantageous for reducing the size of components such as inductors and transformers. In addition, since the dust core can be molded using a die, the degree of freedom of the shape of the magnetic core is high, and even if the shape is complicated, the dust core can be manufactured with high accuracy by a simple process. Therefore, their usefulness has attracted attention.

For example, Patent Literature 1 discloses a molding material including a metal magnetic powder surface-treated with a titanium-based coupling agent or a silane-based coupling agent, and a resin. The metal magnetic powder surface-treated with the coupling agent improves the fluidity of the molding material. When the fluidity of the molding material is improved, the filling factor of the molded body can be enhanced, and thus a dust core having excellent magnetic properties is easily formed.

### CITATION LIST

### Patent Literature

Patent Literature 1: Japanese Unexamined Patent Application No. 2018-135416

### SUMMARY OF THE INVENTION

When a metal magnetic powder is used as the magnetic powder in the dust core, it is required to enhance the insulation properties between the particles of the metal magnetic powder in order to suppress breakage or the like of the dust core. However, in the dust core, when the filling factor of the metal magnetic powder is increased in order to improve the magnetic properties, the gap between the particles of the metal magnetic powder is reduced, and thus the insulation properties are likely to be reduced. Therefore, there is a problem that it is difficult to achieve both magnetic properties and insulation properties in a dust core using the metal magnetic powder.

An object of the present disclosure is to provide a method for manufacturing a dust core capable of achieving both magnetic properties and insulation properties.

A method for manufacturing a dust core according to an aspect of the present disclosure comprises: mixing a metal magnetic powder, a resin, and a metal soap to obtain a granular granulated powder, the metal magnetic powder including a plurality of metal magnetic particles; and pressure-molding the granulated powder obtained. The metal soap is in a liquid state at 25° C., and contains a Ti element.

According to the present disclosure, it is possible to achieve both magnetic properties and insulation properties of a dust core.

### BRIEF DESCRIPTION OF THE DRAWINGS

FIG. 1 is a schematic perspective view showing a configuration of an electrical component including a dust core according to an embodiment.

FIG. 2 is a diagram schematically showing a cross section of the dust core according to the embodiment.

FIG. 3 is a flowchart showing a method for manufacturing the dust core according to the embodiment.

FIG. 4 is a flowchart showing a process of preparing granulated powder according to the embodiment.

FIG. 5A is a diagram showing the relationship between the heat treatment temperature and the magnetic permeability of a dust core sample.

FIG. 5B is a diagram showing the relationship between the heat treatment temperature and the magnetic loss in the sample of the dust core.

FIG. 5C is a diagram showing a relationship between a heat treatment temperature and a breakdown voltage in a sample of a dust core.

FIG. 6A is a diagram showing a relationship between an addition amount of a Ti-based additive and magnetic permeability in a sample of a dust core.

FIG. 6B is a diagram showing a relationship between an addition amount of a Ti-based additive and a magnetic loss in a sample of a dust core.

FIG. 6C is a diagram showing a relationship between an addition amount of a Ti-based additive and a breakdown voltage in a sample of a dust core.

FIG. 7A is a diagram showing the relationship between the total addition amount of a Ti-containing metal soap and a Ti-based coupling agent and the magnetic permeability in a dust core sample.

FIG. 7B is a diagram showing the relationship between the total addition amount of the Ti-containing metal soap and the Ti-based coupling agent and the magnetic loss in the sample of the dust core.

FIG. 7C is a diagram showing the relationship between the total addition amount of the Ti-containing metal soap and the Ti-based coupling agent and the breakdown voltage in the dust core samples.

### DESCRIPTION OF EMBODIMENT

Hereinafter, embodiments of the present disclosure will be specifically described with reference to the drawings.

It is to be noted that each of the embodiments described below illustrates a specific example of the present disclosure. The numerical values, shapes, materials, constituent elements, the arrangement and connection of the constituent elements, steps (processes), the processing order of the steps (processes), etc. illustrated in the following embodiments are mere examples, and are not intended to limit the present disclosure. Further, among the constituent elements in the following embodiments below, constituent elements not recited in any one of the independent claims will be described as optional constituent elements.

The drawings are represented schematically and are not necessarily precise illustrations. Therefore, for example, scales are not necessarily consistent from drawing to drawing. In the drawings, essentially the same constituent elements share the same reference signs, and redundant description will be omitted or simplified.

In addition, in the present specification, terms indicating a relationship between elements such as “parallel” and “orthogonal”, terms indicating the shape of elements such as “rectangular” and “rectangular parallelepiped”, and numerical value range do not represent there strict meanings only but also include substantially equivalent range, e.g., difference of about several percent.

### Embodiment

Hereinafter, a dust core according to an embodiment and an electrical component using the dust core will be described.

### [Configuration]

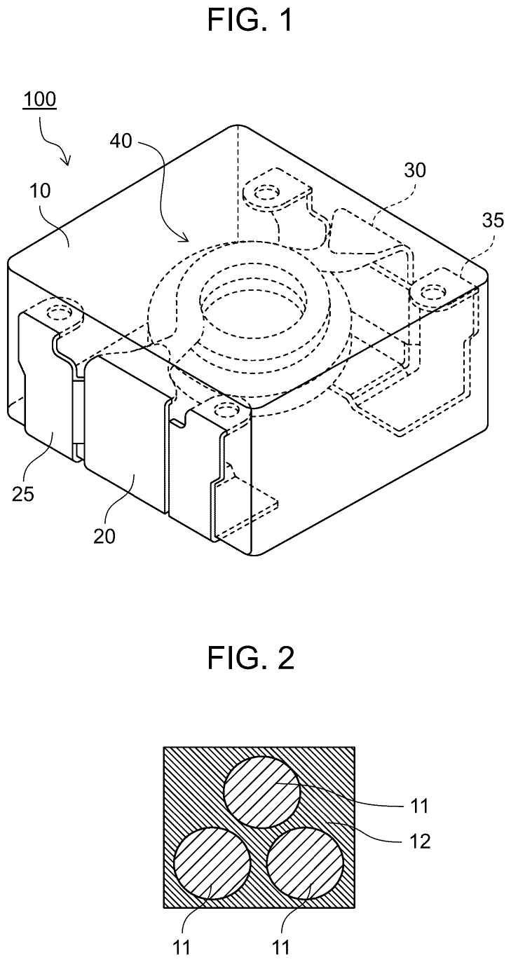

First, a configuration of an electrical component using a dust core according to an embodiment will be described with reference to FIG. 1 and FIG. 2.

FIG. 1 is a schematic perspective view showing a configuration of an electrical component including a dust core according to an embodiment. FIG. 1 shows an outline of dust core 10 described later, and further shows the inside of dust core 10 in a transparent manner. For example, constituent elements invisible by being embedded in dust core 10, such as coil member 40, are illustrated with broken lines to show that such constituent elements are seen through dust core 10.

As shown in FIG. 1, electrical component 100 includes dust core 10, coil member 40, first terminal member 25, and second terminal member 35.

Electrical component 100 is, for example, an inductor having a rectangular parallelepiped shape, and a rough profile of electrical component 100 is determined by the shape of dust core 10. Note that dust core 10 can be formed into any shape by pressure molding. That is to say, any shape of electrical component 100 can be achieved by the shaping dust core 10 through pressure molding. Therefore, the shape of the dust core is not limited to a rectangular parallelepiped shape and may be a different shape.

Electrical component 100 is a passive element that stores electric energy flowing between first terminal member 25 and second terminal member 35 as magnetic energy by coil member 40. In the present embodiment, electrical component 100 will be described as an example of use of dust core 10. Dust core 10 can be used simply as a magnetic material, and the use example is not limited to electrical component 100 according to the present embodiment.

Dust core 10 has substantially quadrangular prism shape having rectangular opposing surfaces on which first terminal member 25 and second terminal member 35 are formed. The respective four sides of the opposing surfaces are connected by a top surface, a bottom surface, and two side surfaces. In the present embodiment, dust core 10 has, for example, a rectangular shape in which the bottom surface and the top surface have dimensions of about 14.0 mm×12.5 mm, and the separation distance from the bottom surface to the top surface is about 8.0 mm.

FIG. 2 is a diagram schematically showing a cross section of dust core 10. FIG. 2 is an enlarged view of a part of the cross section of dust core 10.

As shown in FIG. 2, dust core 10 includes: a metal magnetic powder 11 including a plurality of metal magnetic particles; and binding agent 12 that binds the plurality of metal magnetic particles of metal magnetic powder 11 to each other.

As metal magnetic powder 11, Fe—Si—Al based, Fe—Si based, Fe—Si—Cr based, or Fe—Si—Cr—B based, or the like metal magnetic powder is used. Metal magnetic powder 11 has a high saturation magnetic flux density as compared to magnetic powders such as ferrite, thus being useful for use under a high current.

In the case of using an Fe—Si—Al based metal magnetic powder, for example, the composition elements include Si with a content of 8 wt % or more and 12 wt % or less, Al with a content of 4 wt % or more and 6 wt % or less, and the remaining composition elements including Fe and inevitable impurities. Here, examples of the inevitable impurities include Mn, Ni, P, S, and C, and the like. A high magnetic permeability and a low coercive force can be obtained by setting the content of the composition elements composing metal magnetic powder 11 to the above-mentioned composition ranges.

In the case of using an Fe—Si-based metal magnetic powder, for example, the composition elements include Si with a content of 1 wt % or more and 8 wt % or less, and the remaining composition elements including Fe and inevitable impurities. Note that the inevitable impurities are the same as those described above.

In the case of using an Fe—Si—Cr-based metal magnetic powder, for example, the composition elements include Si with a content of 1 wt % or more and 8 wt % or less, Cr with a content of 2 wt % or more and 8 wt % or less, and the remaining composition elements including Fe and inevitable impurities. Note that the inevitable impurities are the same as those described above.

In the case of using an Fe—Si—Cr—B-based metal magnetic powder, for example, the composition elements include Si with a content of 1 wt % or more and 8 wt % or less, Cr with a content of 2 wt % or more and 8 wt % or less, B with a content of 1 wt % or more and 8 wt % or less, and the remaining composition elements including Fe and inevitable impurities. Note that the inevitable impurities are the same as those described above.

A role of Si in the composition elements of the above-mentioned metal magnetic powder 11 is to impart an effect of reducing eddy current loss by reducing magnetic anisotropy and a magnetostriction constant, and by increasing the electric resistance. By setting the content of Si in the composition elements is 1 wt % or more, it is possible to obtain an effect of improving soft magnetic properties. In addition, by setting the content of Si in the composition elements to 8 wt % or less, it is possible to suppress a decrease in DC saturation characteristics by suppressing a decrease in saturation magnetization.

By causing metal magnetic powder 11 to contain Cr, it is possible to impart an effect of enhancing weatherability. By setting the content of Cr in the composition elements to 2 wt % or more, it is possible to obtain an effect of improving weatherability. By setting the content of Cr in the composition elements to 8 wt % or less, it is possible to suppress deterioration of soft magnetic properties.

The method for producing metal magnetic powder 11 according to the present embodiment is not particularly limited, and various atomization methods and various pulverization methods can be used.

The median diameter D50 of metal magnetic powder 11 is, for example, at least 1.0 μm and at most 35 μm. By setting median diameter D50 of metal magnetic powder 11 to be small, electric field concentration between particles can be relaxed, and insulation properties can be ensured. In addition, by setting the median diameter D50 as above it is possible to ensure a high filling factor and handleability can be ensured. Further, by setting median diameter D50 of metal magnetic powder 11 to 35 μm or less, it is possible to reduce a core loss, particularly, an eddy current loss, in a high frequency region. Median diameter D50 of metal magnetic powder 11 is the particle diameter at which, when a count is started from a particle having a smaller particle diameter by using a particle size distribution meter that performs measurement with a laser diffraction scattering method, the integrated value reaches 50% of the whole.

Binding agent 12 is provided to cover the periphery of the metal magnetic particles of metal magnetic powder 11. Binding agent 12 is located between the metal magnetic particles of metal magnetic powder 11. Binding agent 12 is an insulating resin material containing a resin as a main component. Binding agent 12 includes a resin and a metal soap, for example. Binding agent 12 may further include a coupling agent and/or insulating particles (for example, inorganic particles such as talc particles).

The resin is, for example, a thermosetting resin. Examples of the thermosetting resin include an epoxy resin, a phenol resin, a silicone resin, and a polyimide resin, for example. The resin may also be a thermoplastic resin. Examples of the thermoplastic resin include an acrylic resin, polyethylene, polypropylene, and polystyrene, for example. Binding agent 12 may include a plurality of kinds of resins.

Binding agent 12 may include a Ti element. The Ti element included in binding agent 12 derives from the metal soap, for example. Binding agent 12 includes, for example, a metal soap including the Ti element and/or a reaction product of the metal soap including the Ti element as the constituent including the Ti element.

In dust core 10, a coating derived from the metal soap including the Ti element may be included between the metal magnetic particles of metal magnetic powder 11 and binding agent 12. The coating film is included so as to cover the entire surface of the metal magnetic particles of metal magnetic powder 11, for example.

Subsequently, coil member 40, first terminal member 25, and second terminal member 35 will be described with reference to FIG. 1.

Coil member 40 includes a wound portion around which a conductive wire that is an elongated conductor covered by an insulating film is wound, and lead portion 20 and lead portion 30 in which two ends of the conductive wire are connected to the first terminal member 25 and the second terminal member 35, respectively. In the present embodiment, it is assumed that a round conductive wire having a cross-sectional diameter of about 0.65 mm is used as the conductive wire. The thickness and shape of the conductive wire are not particularly limited. As long as the conducting wire is thick enough to allow winding processing etc., a flat rectangular conducting wire having a rectangular cross section, a round conducting wire, and so on can be selected and used as appropriate. The wound portion is embedded in the vicinity of the center of the dust core 10. In addition, in lead portion 20 and lead portion 30, each of the two ends of the conductive wire continuously extend from the wound portion to a corresponding one of the opposing surface, and protrude to outward from dust core 10. Here, a part of lead portion 20 and a part of lead portion 30 are extended to form a flat shape, and are bent along the corresponding one of the opposing surface and the bottom surface. At the extended part, the insulating film cover is removed to allow electrical connection to the outside.

First terminal member 25 and second terminal member 35 are conductor plate made of, for example, a phosphor bronze material or a copper material. Each of first terminal member 25 and second terminal member 35 has a recess in the vicinity of its center along a corresponding one of the opposing surface and is recessed into dust core 10. Lead portion 20 and lead portion 30 are provided outside the recess. Lead portion 20 and first terminal member 25 are electrically connected to each other. Lead portion 30 and second terminal member 35 are electrically connected to each other. Lead portion 20 and lead portion 30 are connected to first terminal member 25 and second terminal member 35, respectively, by resistance welding or the like. First terminal member 25 and second terminal member 35 are bent to be inserted into the inside of dust core 10, and first terminal member 25 and second terminal member 35 are fixed to dust core 10 in a state where the bent portions are inserted into dust core 10.

First terminal member 25 and second terminal member 35 are bent along the bottom surface of dust core 10 together with lead portion 20 and lead portion 30. As a result, lead portion 20 and lead portion 30 are held by first terminal member 25 and second terminal member 35, and are disposed on the bottom lower side of electrical component 100. That is to say, lead portion 20 and lead portion 30 can be directly connected to a land (not shown) of a mounting substrate or the like on which electrical component 100 is mounted.

Note that first terminal member 25 and second terminal member 35 are not essential constituent components. First terminal member 25 and second terminal member 35 need not be included if lead portions 20 and 30 are strong enough to maintain their shape by themselves.

### [Manufacturing Method]

Next, an example of a method for manufacturing above-described dust core 10 will be described.

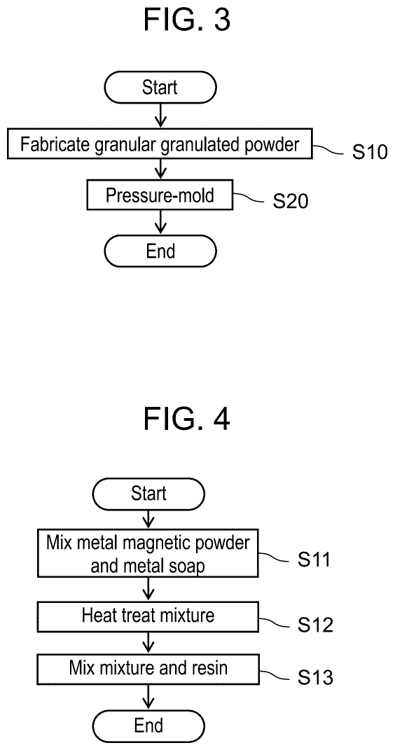

FIG. 3 is a flowchart showing a method for manufacturing the dust core according to the present embodiment.

As shown in FIG. 3, in the method for manufacturing dust core 10 according to the present embodiment, first, metal magnetic powder 11, a resin, and a metal soap are mixed to fabricate granular granulated powder in which metal magnetic powder 11, the resin, and the metal soap are mixed (step S10). Step S10 is an example of a first step. In step S10, for example, metal magnetic powder 11 and a metal soap are mixed to obtain a mixture, and then the mixture and a resin are mixed to obtain a granulated powder.

FIG. 4 is a flowchart showing a process of preparing granulated powder according to the present embodiment. In step S10, granulated powder is obtained by performing each step (step) shown in FIG. 4.

As shown in FIG. 4, in the fabrication of the granulated powder, first, metal magnetic powder 11 and a metal soap are mixed (step S11). In this way, a mixture of metal magnetic powder 11 and the metal soap is obtained. In step S11, the mixture contains substantially no resin. The mixing in step S11 is performed, for example, at room temperature of about 25° C. without particularly performing temperature control such as heating and cooling. When the ambient temperature is low, the metal soap may be heated to a temperature of about 40° C. or lower and mixed in order to maintain the metal soap in a liquid state.

The metal soap includes the Ti element. Specifically, the metal soap is fatty acid titanium. The metal soap to be mixed is liquid at 25° C. (normal temperature). That is, the melting point of the metal soap is lower than 25° C. Therefore, in step S11, metal magnetic powder 11 is mixed with the metal soap in a liquid state. The metal soap on a liquid state has a branch in the hydrocarbon chain of the fatty acid, in order to decrease the melting point. Metal soaps are manufactured in a direct method or double decomposition method, for example. The direct method is a method of directly reacting a fatty acid with a metal oxide or a metal hydroxide. The double decomposition method is a method in which a fatty acid is reacted with a basic compound in an aqueous solution state to obtain a basic compound of the fatty acid, and the basic compound is further reacted with a metal salt containing a metal or a semimetal.

As described above, by mixing metal magnetic powder 11 and the metal soap in a liquid state before mixing the resin, the surface of the metal magnetic particles of metal magnetic powder 11 and the hydrophilic portion of the metal soap easily interact with each other, and the metal soap can effectively work. In addition, since the metal soap is in a liquid state, dispersibility is high, and the metal soap easily acts uniformly on the surfaces of the metal magnetic particles of metal magnetic powder 11.

In step S11, in order to facilitate mixing of metal magnetic powder 11 and the metal soap, a solvent may be further added and mixed. When the solvent is added, the solvent is evaporated by heating at a temperature of, for example, 65° C. or more and 150° C. or less after mixing, and the solvent is removed from the mixture. As the solvent, for example, toluene, xylene, ethanol, isopropyl alcohol, acetone, methyl ethyl ketone, or the like is used.

Next, the mixture of metal magnetic powder 11 and the metal soap obtained in step S11 is subjected to heat treatment (step S12). By such heat treatment, a strong coating derived from the metal soap is formed on the surface of the metal magnetic particles of metal magnetic powder 11. The heating method is not particularly limited, and the heating is performed using, for example, a heating furnace such as an electric furnace. When the mixture is heated to remove the solvent in step S11, the heat treatment may be performed continuously with the removal of the solvent.

The heat treatment in step S12 is performed under a temperature condition of, for example, 200° C. or more and 800° C. or less. From the viewpoint of enhancing the work of the coating derived from the metal soap, the temperature condition of the heat treatment may be 400° C. or more and 600° C. or less. The time of the heat treatment (the time of treatment at the target temperature) is, for example, 20 minutes or more and 120 minutes or less.

In step S12, for example, the heat treatment of the mixture is performed in a non-oxidizing atmosphere such as nitrogen gas. As a result, deterioration due to oxidation of the mixture is suppressed.

As described above, in the fabrication of the granulated powder, after the mixture is obtained, the mixture is subjected to the heat treatment before the mixture and the resin are mixed.

Next, a resin is further added to the mixture subjected to the heat treatment in step S12, and the mixture and the resin are mixed (step S13). Thus, granular granulated powder in which metal magnetic powder 11, the resin, and the metal soap are mixed is obtained. The mixing in step S13 is performed, for example, at room temperature of about 25° C. without particularly performing temperature control such as heating and cooling.

The resin mixed in step S13 is dissolved in a solvent in advance, for example. The resin mixed in step S13 may not be dissolved in the solvent. As the solvent, for example, those exemplified as the solvent used in step S11 described above are used. The resin is a resin serving as a main component of binding agent 12 described above. In step S13, two or more kinds of resins may be mixed.

In step S13, after the mixture subjected to the heat treatment in step S12 and the resin are mixed, the solvent is evaporated by heating at a temperature of, for example, 65° C. or more and 150° C. or less, and the mixture after the solvent evaporation is pulverized to obtain granular granulated powder (composite magnetic material) having high moldability. Further, the granulated powder may be classified to obtain a granulated powder having a particle size within a predetermined range. Accordingly, the moldability can be further improved.

The mixing in step S11 and step S13 is performed using, for example, a mortar, a mixer, a ball mill, a V-type mixer, a cross rotary, or the like.

In step S11 and/or step S13, other materials such as a coupling agent may be further added and mixed as necessary. When the metal soap and the coupling agent are used in combination in the fabrication of the granulated powder, excellent magnetic properties and insulation properties are easily realized even when the addition amount of the metal soap is reduced. The coupling agent is, for example, a titanate-based coupling agent. The other material may contain insulating particles.

Through the above steps, in the fabrication of the granulated powder, metal magnetic powder 11, the resin, and the metal soap are mixed to obtain the granular granulated powder in which metal magnetic powder 11, the resin, and the metal soap are mixed. It can also be said that the obtained granulated powder is a granulated powder including metal magnetic powder 11 and binding agent 12 described above.

In the fabrication of the granulated powder, the mixing ratio of the metal soap to metal magnetic powder 11 (that is, the ratio of the addition amount of the metal soap to the addition amount of metal magnetic powder 11) is, for example, at least 0.01 wt % and at most 2.0 wt %. This can effectively improve the magnetic properties and insulation properties of the dust core 10. From the viewpoint of further improving the magnetic properties and insulation properties of dust core 10, the mixing ratio of the metal soap may be at least 0.05 wt % and at most 2.0 wt %, at least 0.1 wt % and at most 2.0 wt %, or at least 0.15 wt % and at most 1.0 wt %.

In the fabrication of the granulated powder, the mixing ratio of the resin to metal magnetic powder 11 (that is, the ratio of the addition amount of the resin to the addition amount of metal magnetic powder 11) is, for example, at least 1 wt % and at most 10 wt %.

In step S13, the granulated powder may be obtained by mixing the resin with the mixture of metal magnetic powder 11 and the metal soap, which is not subjected to the heat treatment without performing step S12.

In the above description, metal magnetic powder 11, the resin, and the metal soap are mixed separately in step S11 and step S13. However, the present invention is not limited thereto. The order of mixing metal magnetic powder 11, the resin, and the metallic soap may be different from the order described above, as far as a granular granulated powder including a mixture of metal magnetic powder 11, the resin, and the metallic soap. For example, metal magnetic powder 11, the resin, and the metal soap may be mixed at same time. Further, a combination of materials different from the above may be mixed in two or more steps.

Referring to FIG. 3 again, after step S10, the granulated powder obtained in step S10 is put into a die and press-molded into a desired shape to obtain the dust core 10 (step S20). Step S20 is an example of a second step. In step S20, for example, pressure molding is performed at a pressure in a range of 3 tons/cm² or more and 7 tons/cm² or less. In addition, a hardening treatment is performed on the pressed dust core 10 by, for example, heating. The conditions of the hardening treatment are set according to the kinds of resin used.

Through the above steps, dust core 10 is produced. Prepared dust core 10 is used as a part of the electrical component 100 in which a coil is embedded. In step S20, the granulated powder may be pressure-molded together with the coil member 40.

As described above, the method for manufacturing dust core 10 includes a first step (step S10) of mixing metal magnetic powder 11, a resin, and a metal soap to obtain a granular granulated powder, and a second step (step S20) of pressure-molding the obtained granulated powder to obtain a molded body. The metal soap is liquid at 25° C. and contains Ti element.

Thus, in the process of manufacturing dust core 10, the liquid metal soap including the Ti element covers the surfaces of the metal magnetic particles of metal magnetic powder 11. Therefore, the affinity between metal magnetic powder 11 and the resin is improved, the gap between the metal magnetic particles of metal magnetic powder 11 is likely to be reduced in pressure molding, the filling factor is improved, and the magnetic properties of the dust core are improved. Further, the metal soap including the Ti element protects the metal magnetic particles by forming a coating film on the surface of the metal magnetic particles of metal magnetic powder 11. Therefore, even when the gap between the metal magnetic particles is reduced, the metal magnetic particles are less likely to come into contact with each other, and the insulation properties of the dust core are also improved. Therefore, the method for manufacturing dust core 10 according to the present embodiment can achieve both magnetic properties and insulation properties of dust core 10.

### [Evaluation of Dust Core]

Next, evaluation results of the dust core according to the embodiment will be described. Specifically, a dust core was fabricated as described below, and analysis and characteristics evaluation of the fabricated dust core were evaluated. Note that the present embodiment is not limited to the evaluation described below in any sense.

### <Fabrication of Dust Core>

First, fabrication of a sample of the dust core used for evaluation will be described.

In the preparation of the samples used for the evaluation, first, a metal magnetic powder, a resin, and a Ti-based additive were prepared.

As the metal magnetic powder, the metal magnetic powder (Fe—Si-based metal magnetic powder or Fe—Si—Cr-based metal magnetic powder) shown in Tables 1 to 3 below was used.

As the resin, a modified silicone resin having a methyl group and a phenyl group in a side chain dissolved in a solvent (isopropyl alcohol) in advance (concentration: 50%) was used. The addition amount of the resin with respect to the addition amount of the metal magnetic powder was set to the addition amount (wt %) shown in Tables 1 to 3. Note that the addition amount of the resin is an addition amount by weight excluding the solvent.

As the Ti-based additive, a metal soap including a Ti element (hereinafter, also referred to as “Ti-containing metal soap”) and/or a titanate-based coupling agent (hereinafter, also referred to as “Ti-based coupling agent”) was used. As the Ti-containing metal soap, fatty acid titanium which is liquid at 25° C. and has a branched hydrocarbon chain was used. For the Ti-based coupling agent was liquid at 25° C. The addition amount (wt %) of the Ti-based additive with respect to the addition amount of the metal magnetic powder was set to the addition amount shown in Tables 1 to 3. As shown in Tables 1 to 3, the Ti-based additive was not added to some samples.

Using these materials, first, the metal magnetic powder, the liquid Ti-based additive, and toluene were mixed. Thereafter, toluene was removed by heating at 90° C. for 90 minutes to obtain a mixture of the metal magnetic powder and the Ti-based additive. Then, the mixture was heat-treated for 30 minutes under the temperature conditions shown in Tables 1 to 3. The heat treatment was performed under nitrogen gas. As shown in Tables 1 to 3, some samples were not subjected to heat treatment. Next, a resin was further added to and mixed with the mixture, and then the mixture was heated to remove the solvent and pulverized to fabricate a granular granulated powder. That is, the granulated powder was fabricated by the method described above with reference to FIG. 4.

The fabricated granulated powder was subjected to pressure molding at room temperature under a pressure of 4 ton/cm² to prepare a ring core having an outer diameter of 14.4 mm, an inner diameter of 10.3 mm, and a thickness of 4.4 mm for evaluation of magnetic permeability and magnetic loss. Further, the ring core was dried for 2 hours under a temperature condition of 150° C. to cure the resin, thereby fabricating a ring-shaped dust core sample.

In addition, the fabricated granulated powder was subjected to pressure molding at room temperature under a pressure of 4 ton/cm² to prepare a plate-shaped molded body having a length of 12 mm, a width of 12 mm, and a thickness of 0.70 mm for evaluation of breakdown voltage. Further, the plate-shaped molded body was dried for 2 hours under a temperature condition of 150° C. to cure the resin, thereby fabricating a plate-shaped dust core sample.

### <Method of Calculating Magnetic Permeability>

The magnetic permeability was obtained by measuring the inductance L of the ring-shaped dust core at an applied magnetic field of 0 oersted (Oe) using an LCR meter, and calculating the initial magnetic permeability (the following magnetic permeability μi) from the following formula (1) (at a measurement frequency: 100 kHz). A high magnetic permeability μi indicates that the magnetic properties of the dust core are good.

$$μ i = ( L \times le ) / ( μ0 \times A e \times {n}^{2 )} \qquad ( 1 )$$

Note that le represents the effective magnetic path length, μ0 represents the vacuum magnetic permeability, Ae represents the cross-sectional area, and n represents the number of turns of the measurement coil.

### <Method of Calculating Magnetic Loss>

The magnetic loss of the ring-shaped dust core was measured using a B—H analyzer under the conditions of Bm=25 mT and frequency=1 MHz. The magnetic loss can be used as an evaluation index of the magnetic properties of the dust core. A low magnetic loss indicates that the dust core has good magnetic properties.

### <Evaluation Method of Breakdown Voltage>

In the measurement of the breakdown voltage serving as an index of insulation properties, a sample of the prepared plate-shaped dust core was sandwiched between conductive rubbers disposed on both main surfaces, a DC voltage having an initial value of 10 V was applied, and thereafter, the applied voltage value was continuously increased at a pace of 5 V/min, and a value (V/mm) obtained by dividing the applied voltage value immediately before dielectric breakdown by the thickness of the molded body was defined as the breakdown voltage value of each dust core. A higher value of breakdown voltage value of dust core indicates higher insulation properties.

### <Evaluation Result 1>

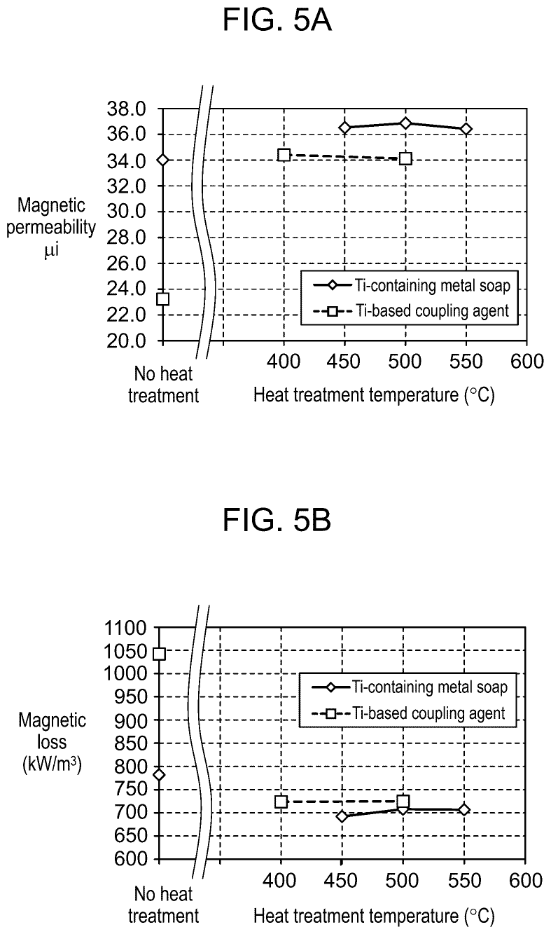

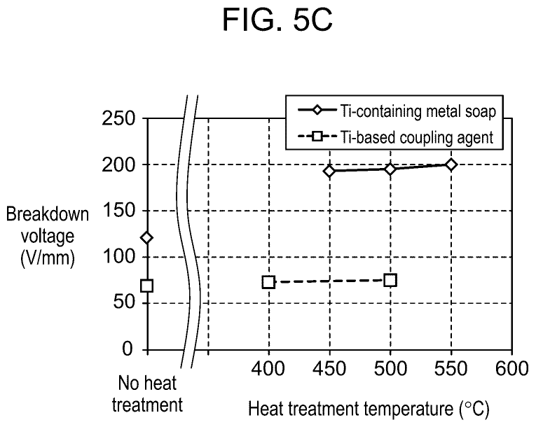

First, with reference to Table 1 and FIGS. 5A to 5C, a description will be given of results of evaluation of magnetic properties and insulation properties by changing the kinds of Ti-based additive used in the production of the granulated powder and the heat treatment temperature in the production of the granulated powder.

Table 1 shows the kinds of the metal magnetic powder, the addition amount of the resin, the kinds and addition amount of the Ti-based additive, the heat treatment temperature, the magnetic permeability, the magnetic loss, and the breakdown voltage of each of the dust core samples used for the evaluation. FIG. 5A is a diagram showing the relationship between the heat treatment temperature and the magnetic permeability in the samples shown in Table 1. FIG. 5B is a diagram showing the relationship between the heat treatment temperature and the magnetic loss in the samples shown in Table 1. FIG. 5C is a diagram showing the relationship between the heat treatment temperature and the breakdown voltage in the samples shown in Table 1. That is, FIGS. 5A to 5C are diagram of the data of Table 1. In FIG. 5A, the vertical axis represents the magnetic permeability. In FIG. 5B, the vertical axis represents the magnetic loss. In FIG. 5C, the vertical axis represents the breakdown voltage. In each of FIGS. 5A to 5C, the horizontal axis represents the heat treatment temperature in the heat treatment of the mixture of the metal magnetic powder and the Ti-based additive. In addition, in FIGS. 5A to 5C, the evaluation results of samples A1 to A4 in which only the Ti-containing metal soap was used as the Ti-based additive (“Ti-containing metal soap” in the legend in the drawings) and the evaluation results of samples B1 to B3 in which only the Ti-based coupling agent was used (“Ti-based coupling agent” in the legend in the drawings) are indicated by markers having shapes different from each other.

TABLE 1

| | | | Addition amount of | | | | | |
|---|---|---|---|---|---|---|---|---|
| | | | Ti-based additive | | | | | |
| | | Addition | (wt %) | | | | | |
| | Metal | amount | Ti- | Ti-based | Heat treatment | Magnetic | Magnetic | Breakdown |
| | magnetic | of resin | containing | coupling | temperature | permeability | loss | voltage |
| Sample | powder | (wt %) | metal soap | agent | (° C.) | μi | (kW/m³) | (V/mm) |
| A1 | Fe-Si | 3 | 0.25 | 0 | No heat treatment | 34.1 | 782 | 121 |
| A2 | Fe-Si | 3 | 0.25 | 0 | 450 | 36.5 | 692 | 193 |
| A3 | Fe-Si | 3 | 0.25 | 0 | 500 | 36.9 | 708 | 195 |
| A4 | Fe-Si | 3 | 0.25 | 0 | 550 | 36.4 | 707 | 200 |
| B1 | Fe-Si | 3 | 0 | 0.5 | No heat treatment | 23.3 | 1042 | 69 |
| B2 | Fe-Si | 3 | 0 | 0.5 | 400 | 34.4 | 724 | 73 |
| B3 | Fe-Si | 3 | 0 | 0.5 | 500 | 34.1 | 725 | 75 |

As shown in Table 1, the samples A1 to A4 are samples fabricated by using the Ti-containing metal soap as the Ti-based additive in an addition amount of 0.25 wt % and changing the heat treatment temperature. Samples B1 to B3 are samples fabricated by using a Ti-based coupling agent as the Ti-based additive in an addition amount of 0.5 wt % and changing the heat treatment temperature.

As shown in Table 1 and FIGS. 5A to 5C, under the same heat treatment temperature conditions, the samples A1 to A4 using the Ti-containing metal soap have higher magnetic permeability and breakdown voltage and lower magnetic loss than the samples B1 to B3 using the Ti-based coupling agent. For example, when sample A1 and sample B1, which are samples not subjected to heat treatment, are compared, sample A1 has higher magnetic permeability and breakdown voltage and lower magnetic loss than sample B1. In addition, for example, when sample A3 and sample B3, which are samples subjected to heat treatment at 500° C., are compared, sample A3 has higher magnetic permeability and breakdown voltage and lower magnetic loss than sample B3. That is, the use of the Ti-containing metal soap as the Ti-based additive can improve the magnetic properties and the insulation properties of the dust core more than the use of the Ti-based coupling agent.

Since the Ti-containing metal soap has a long hydrocarbon chain, the affinity with the resin is higher than that of the Ti-based coupling agent, and the gap between the metal magnetic particles is easily reduced during molding. Therefore, it is considered that the samples A1 to A4 have higher magnetic permeability and lower magnetic loss than the samples B1 to B3. In addition, the Ti-containing metal soap is more likely to be present on the surface of the metal magnetic particles than the Ti-based coupling agent, for example, the Ti-containing metal soap is more likely to form a coating film on the surface of the metal magnetic particles. Therefore, it is considered that samples A1 to A4 have higher breakdown voltages than samples B1 to B3.

Further, as shown in Table 1 and FIGS. 5A and 5B, in both of the samples A1 to A4 using the Ti-containing metal soap and the samples B1 to B3 using the Ti-based coupling agent, the magnetic permeability is improved and the magnetic loss is reduced by performing the heat treatment. It is considered that this is because the Ti-based additive is immobilized on the surface of the metal magnetic particles by the heat treatment to form a coating film, the affinity between the metal magnetic powder and the resin is effectively increased, and the gap between the metal magnetic particles is easily reduced during molding.

On the other hand, as shown in Table 1 and FIG. 5C, in samples A1 to A4 using the Ti-containing metal soap, the breakdown voltage is significantly increased by performing the heat treatment, but in samples B1 to B3 using the Ti-based coupling agent, the breakdown voltage hardly changes even when the heat treatment is performed. As described above, by performing the heat treatment using the Ti-containing metal soap, a dust core having significantly improved insulation properties can be realized. It is considered that this is because the Ti-containing metal soap having a long hydrocarbon chain forms a strong coating film on the surface of the metal magnetic particles by the heat treatment, and contact between the metal magnetic particles is suppressed in the dust core.

### <Evaluation Result 2>

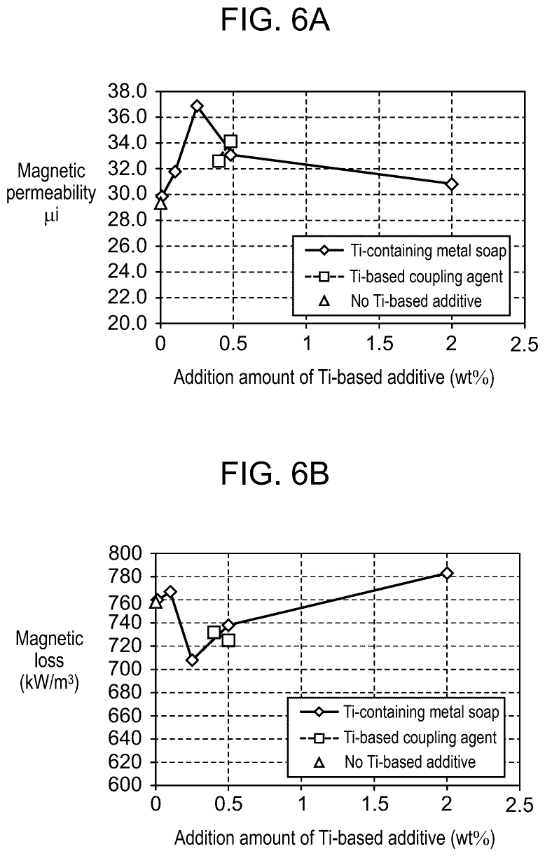

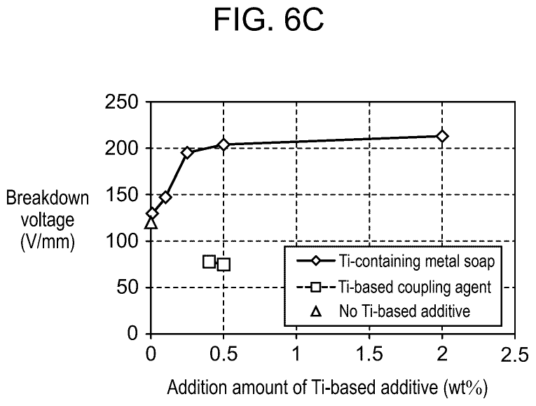

Next, with reference to Table 2 and FIGS. 6A to 6C, a description will be given of the results of evaluating the magnetic properties and the insulation properties by changing the addition amount of the Ti-based additive used for fabricating the granulated powder.

Table 2 shows the kinds of the metal magnetic powder, the addition amount of the resin, the kinds and addition amount of the Ti-based additive, the heat treatment temperature, the magnetic permeability, the magnetic loss, and the breakdown voltage of each of the dust core samples used for the evaluation. FIG. 6A is a diagram showing the relationship between the addition amount of the Ti-based additive and the magnetic permeability in the samples shown in Table 2. FIG. 6B is a diagram showing the relationship between the addition amount of the Ti-based additive and the magnetic loss in the samples shown in Table 2. FIG. 6C is a diagram showing the relationship between the addition amount of the Ti-based additive and the breakdown voltage in the samples shown in Table 2. That is, FIGS. 6A to 6C are graphs of the data of Table 2. In FIG. 6A, the vertical axis represents the magnetic permeability. In FIG. 6B, the vertical axis represents the magnetic loss. In FIG. 6C, the vertical axis represents the breakdown voltage. In addition, in any of FIGS. 6A to 6C, the horizontal axis represents the addition amount of the Ti-based additive (the Ti-containing metal soap or the Ti-based coupling agent) at the time of preparing the granulated powder. In addition, in FIGS. 6A to 6C, the evaluation results of samples A3 and A5 to A8 in which only the Ti-containing metal soap is used as the Ti-based additive (“Ti-containing metal soap” in the legend in the drawings), and the evaluation results of samples B3 and B4 in which only the Ti-based coupling agent is used (“Ti-based coupling agent” in the legend in the drawings), and the evaluation result of sample C1 in which the Ti-based additive was not used (“no Ti-based additive” in the legend in the drawings) are indicated by markers having shapes different from each other.

TABLE 2

| | | | Addition amount of | | | | | |
|---|---|---|---|---|---|---|---|---|
| | | | Ti-based additive | | | | | |
| | | Addition | (wt %) | | Heat | | | |
| | Metal | amount | Ti- | Ti-based | treatment | Magnetic | Magnetic | Breakdown |
| | magnetic | of resin | containing | coupling | temperature | permeability | loss | voltage |
| Sample | powder | (wt %) | metal soap | agent | (° C.) | μi | (kW/m³) | (V/mm) |
| C1 | Fe-Si | 3 | 0 | 0 | 500 | 29.3 | 758 | 120 |
| A5 | Fe-Si | 3 | 0.01 | 0 | 500 | 29.9 | 760 | 130 |
| A6 | Fe-Si | 3 | 0.1 | 0 | 500 | 31.8 | 767 | 147 |
| A3 | Fe-Si | 3 | 0.25 | 0 | 500 | 36.9 | 708 | 195 |
| A7 | Fe-Si | 3 | 0.5 | 0 | 500 | 33.1 | 738 | 204 |
| A8 | Fe-Si | 3 | 2 | 0 | 500 | 30.8 | 783 | 213 |
| B4 | Fe-Si | 3 | 0 | 0.4 | 500 | 32.6 | 732 | 78 |
| B3 | Fe-Si | 3 | 0 | 0.5 | 500 | 34.1 | 725 | 75 |

Table 2 also shows the evaluation results of some of the dust core samples shown in Table 1. The same samples as those in Table 1 are denoted by the same identification symbols in Table 2.

As shown in Table 2, samples A3 and A5 to A8 are samples fabricated by performing heat treatment under a temperature condition of 500° C., using a Ti-containing metal soap as a Ti-based additive, and changing the addition amount of the Ti-containing metal soap to each other. Samples B3 and B4 are samples fabricated by performing heat treatment under a temperature condition of 500° C., using a Ti-based coupling agent as a Ti-based additive, and changing the addition amount of the Ti-based coupling agent to each other. Sample C1 is a sample in which heat treatment was performed under a temperature condition of 500° C. and no Ti-based additive was added.

As shown in Table 2 and FIGS. 6A and 6B, the samples A3 and A5 to A8 using the Ti-containing metal soap as the Ti-based additive have higher magnetic permeability and breakdown voltage than the sample C1 not containing the Ti-based additive. In addition, as compared with the sample C1 in which the Ti-based additive is not added, in the samples A3 and A5 to A8 in which the Ti-containing metal soap is used as the Ti-based additive, although the magnetic loss slightly fluctuates depending on the addition amount, the fluctuation is about 50 kW/m³ and is small. As described above, by adding the Ti-containing metal soap, both the magnetic properties and the insulation properties are improved, and both the magnetic properties and the insulation properties can be achieved.

In addition, in the evaluation of samples A3 and A5 to A8, the breakdown voltage increases as the addition amount of the Ti-containing metal soap increases. This is considered to be because the Ti-containing metal soap forms a strong coating film on the surface of the metal magnetic particles, and the coating film becomes stronger as the addition amount increases. In addition, in the evaluation of samples A3 and A5 to A8, when the addition amount of the Ti-containing metal soap is 0.25 wt %, the magnetic permeability is the largest and the magnetic loss is the smallest. It is considered that this is because the affinity between the metal magnetic powder and the resin is increased by the effect of the Ti-containing metal soap, and the gap between the metal magnetic particles is easily reduced during molding. On the other hand, it is considered that when the addition amount is large, the component derived from the Ti-containing metal soap increases, and the gap between the metal magnetic particles is easily widened.

In addition, as compared with the sample C1 in which the Ti-based additive was not added, in the samples B3 and B4 in which the Ti-based coupling agent was used as the Ti-based additive, although the magnetic permeability was increased, the magnetic loss was decreased, and the magnetic properties were improved, the breakdown voltage was decreased, and the insulation properties were decreased. As described above, when the Ti-based coupling agent is used, both the magnetic properties and the insulation properties cannot be achieved. The reason for this is considered as follows. The affinity between the metal magnetic powder and the resin is increased by the Ti-based coupling agent, and thus the gap between the metal magnetic particles is reduced during molding, so that the magnetic properties are improved. However, the formation of the coating film on the surface of the metal magnetic particles by the Ti-based coupling agent is insufficient, and thus the metal magnetic particles easily come into contact with each other, so that the insulation properties are deteriorated.

### <Evaluation Result 3>

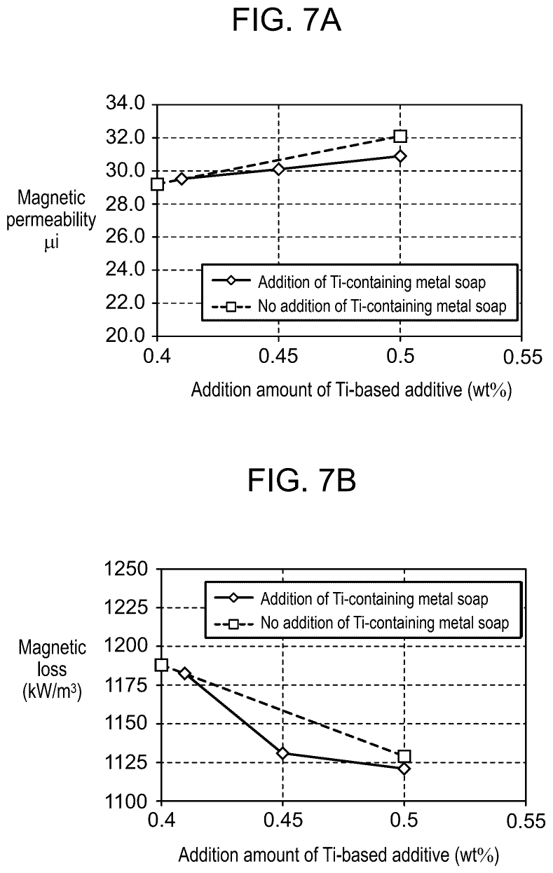

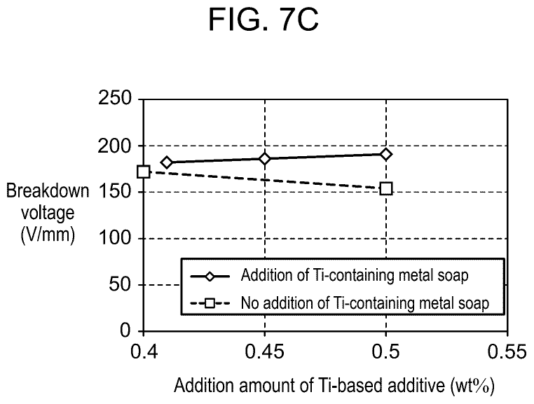

Next, in a case where a Ti-based coupling agent is used as the Ti-based additive used for fabricating the granulated powder, a Ti-containing metal soap is further added, and the results of evaluating the magnetic properties and the insulation properties will be described with reference to Table 3 and FIGS. 7A to 7C.

Table 3 shows the kinds of the metal magnetic powder, the addition amount of the resin, the kinds and addition amount of the Ti-based additive, the heat treatment temperature, the magnetic permeability, the magnetic loss, and the breakdown voltage of each of the dust core samples used for the evaluation. FIG. 7A is a diagram showing the relationship between the addition amount of the Ti-based additive and the magnetic permeability in the samples shown in Table 3. FIG. 7B is a diagram showing the relationship between the addition amount of the Ti-based additive and the magnetic loss in the samples shown in Table 3. FIG. 7C is a diagram showing the relationship between the addition amount of the Ti-based additive and the breakdown voltage in the samples shown in Table 3. That is, FIGS. 7A to 7C are graphs of the data of Table 3. In FIG. 7A, the vertical axis represents the magnetic permeability. In FIG. 7B, the vertical axis represents the magnetic loss. In FIG. 7C, the vertical axis represents the breakdown voltage. In addition, in any of FIGS. 7A to 7C, the horizontal axis represents the addition amount of the Ti-based additive (the total addition amount of the Ti-containing metal soap and the Ti-based coupling agent) at the time of preparing the granulated powder. In addition, in FIGS. 7A to 7C, the evaluation results of samples D1 to D3 in which both the Ti-containing metal soap and the Ti-based coupling agent are used as the Ti-based additive (“addition of Ti-containing metal soap” in the legend in the drawings) and the evaluation results of samples B5 and B6 in which only the Ti-based coupling agent is used as the Ti-based additive (“no addition of Ti-containing metal soap” in the legend in the drawings) are indicated by markers having shapes different from each other.

TABLE 3

| | | | Addition amount of | | | | | | |
|---|---|---|---|---|---|---|---|---|---|
| | | | Ti-based additive | | | | | | |
| | | Addition | (wt %) | | | | | | |
| | Metal | amount | Ti- | Ti-based | | Heat treatment | Magnetic | Magnetic | Breakdown |
| | magnetic | of resin | containing | coupling | | temperature | permeability | loss | voltage |
| Sample | powder | (wt %) | metal soap | agent | total | (° C.) | μi | (kW/m³) | (V/mm) |
| B5 | Fe-Si-Cr | 3.5 | 0 | 0.4 | 0.4 | No heat treatment | 29.2 | 1188 | 172 |
| B6 | Fe-Si-Cr | 3.5 | 0 | 0.5 | 0.5 | No heat treatment | 32.1 | 1129 | 154 |
| D1 | Fe-Si-Cr | 3.5 | 0.01 | 0.4 | 0.41 | No heat treatment | 29.5 | 1183 | 182 |
| D2 | Fe-Si-Cr | 3.5 | 0.05 | 0.4 | 0.45 | No heat treatment | 30.1 | 1131 | 186 |
| D3 | Fe-Si-Cr | 3.5 | 0.1 | 0.4 | 0.5 | No heat treatment | 30.9 | 1121 | 191 |

As shown in Table 3, Samples B5 and B6 are samples fabricated by using only the Ti-based coupling agent as the Ti-based additive without performing the heat treatment in the fabrication of the granulated powder and changing the addition amount of the Ti-based coupling agent to each other. In addition, samples D1 to D3 are samples fabricated by using a Ti-containing metal soap and a Ti-based coupling agent in combination as a Ti-based additive without performing heat treatment and changing the addition amount of the Ti-containing metal soap to each other in the fabrication of the granulated powder. The dust core samples shown in Table 3 are different from the dust core samples shown in Tables 1 and 2 in the composition of the metal magnetic powder and the addition amount of resin.

As shown in Table 3 and FIGS. 7A to 7C, in the samples D1 to D3 in which the Ti-containing metal soap was added in addition to the Ti-based coupling agent, the magnetic permeability was slightly lower than that of the samples B5 and B6 in which only the Ti-based coupling agent was added, but the breakdown voltage was higher and the magnetic loss was the same or lower, when compared at the same addition amount of the Ti-based additive. In particular, when only the Ti-based coupling agent is added, the breakdown voltage decreases as the addition amount increases. However, when the Ti-containing metal soap is used in combination, the breakdown voltage increases, and both magnetic properties and insulation properties can be achieved. It is considered that this is because the Ti-containing metal soap has affinity for both the Ti-based coupling agent and the metal magnetic powder, and thus the effect of improving the magnetic properties of the Ti-based coupling agent is hardly hindered, and the formation of a coating film on the surface of the metal magnetic particles, which is insufficient with the Ti-based coupling agent, is assisted, and the insulation properties are improved.

### <Summary>

From the results of the evaluation of the dust core described above, it was found that the magnetic permeability and the breakdown voltage of the dust core were increased by mixing the Ti-containing metal soap in a liquid state at 25° C. and the metal magnetic powder in the fabrication of the granulated powder, and both the magnetic properties and the insulation properties of the dust core could be achieved.

In addition, it was found that the magnetic permeability and the breakdown voltage were further increased, the magnetic loss was reduced, and the magnetic properties and the insulation properties were further improved by performing the heat treatment on the mixture of the Ti-containing metal soap and the metal magnetic powder in the production of the granulated powder.

### Other Embodiments, Etc.

Although the dust core according to the embodiment of the present disclosure has been described above, the present disclosure is not limited to this embodiment.

For example, an electrical component using the dust core described above is also included in the present disclosure. Examples of the electrical component include inductance components such as a high-frequency reactor, an inductor, and a transformer. In addition, a power supply device including the above-described electrical component is also included in the present disclosure.

Further, the present disclosure is not limited to the above-described embodiments. Those skilled in the art will readily appreciate that many modifications are possible in the exemplary embodiments without materially departing from the novel teachings and advantages of this disclosure. Accordingly, all such modifications are intended to be included within the scope of this disclosure.

### INDUSTRIAL APPLICABILITY

The dust core according to the present disclosure can be applied to a material of a magnetic core of an inductor or a transformer for high frequency.

### REFERENCE MARKS IN THE DRAWINGS

10 dust core
11 metal magnetic powder
12 binding agent
20, 30 lead portion
25 first terminal member
35 second terminal member
40 coil member
100 electrical component

1. A method for manufacturing a dust core, the method comprising:
mixing a metal magnetic powder, a resin, and a metal soap to obtain a granular granulated powder, the metal magnetic powder including a plurality of metal magnetic particles; and
pressure-molding the granular granulated powder obtained,
wherein in the mixing, the metal soap is in a liquid state at 25° C. and includes a Ti element.

2. The method for manufacturing the dust core according to claim 1,
wherein in the mixing, a mixing ratio of the metal soap to the metal magnetic powder is at least 0.01 wt % and at most 2.0 wt %.

3. The method for manufacturing the dust core according to claim 1,
wherein in the mixing, the granular granulated powder is obtained by obtaining a mixture of the metal magnetic powder and the metal soap and then mixing the mixture and the resin.

4. The method for manufacturing the dust core according to claim 3,
wherein in the mixing, after the mixture is obtained and before the mixture and the resin are mixed, the mixture is subjected to a heat treatment under a temperature condition of at least 400° C. and at most 600° C. or lower.

5. The method for manufacturing the dust core according to claim 4,
wherein in the mixing, the heat treatment is performed in a non-oxidizing atmosphere.
